(19) United States
(12) Patent Application Publication
(10) Pub. No.: US 2015/0208016 A1
(43) Pub. Date: Jul. 23, 2015

(54) FLEXIBLE VIDEO DISPLAY IN USE WITH A SHEET OF TRANSPARENT MATERIAL

(71) Applicant: Kevin Rymer, Stillwater, OK (US)

(72) Inventor: Kevin Rymer, Stillwater, OK (US)

(21) Appl. No.: 14/601,980

(22) Filed: Jan. 21, 2015

Related U.S. Application Data
(60) Provisional application No. 61/929,810, filed on Jan. 21, 2014.

(51) Int. Cl. H04N 5/64; H04N 5/66; H04N 5/63

(52) U.S. Cl. CPC H04N 5/64; H04N 5/63; H04N 5/66

(57) ABSTRACT

The present invention is directed to a display apparatus that includes a flexible video display and/or a flexible solar panel. The flexible video display and/or a flexible solar panel have an extended position out of the housing and a retracted position in the housing. The flexible video display and/or a flexible solar panel can be disposed adjacent to the first sheet of transparent material when the flexible video display and/or a flexible solar panel is in the extended position.

### CROSS-REFERENCE TO RELATED APPLICATIONS

The present application is a conversion of U.S. Provisional Application having U.S. Ser. No. 61/929,810, filed Jan. 21, 2014, which claims the benefit under 35 U.S.C. 119(e), the disclosure of which is hereby expressly incorporated herein by reference.

### STATEMENT REGARDING FEDERALLY SPONSORED RESEARCH OR DEVELOPMENT

Not Applicable.

### BACKGROUND OF THE DISCLOSURE

1. Field of the Invention

The present disclosure relates to a flexible video display in use with at least a single pane of transparent material.

2. Description of the Related Art

Flexible video displays have been previously created, but they have primarily been limited to use as a screen for use with computers.

Accordingly, there is a need for alternate uses of flexible video displays.

### SUMMARY OF THE DISCLOSURE

The present disclosure is directed toward a display apparatus that includes a first sheet of transparent material supported by a housing. The display apparatus also includes a video display having an extended position out of the housing and a retracted position in the housing. The video display is disposed adjacent to the first sheet of transparent material when the video display is in the extended position.

The present disclosure is also directed to a display apparatus that includes a first sheet of transparent material supported by a housing. The display apparatus also includes a flexible solar panel having an extended position out of the housing and a retracted position in the housing. The flexible solar panel is disposed adjacent to the first sheet of transparent material when the flexible solar panel is in the extended position.

### BRIEF DESCRIPTION OF THE DRAWINGS

FIG. 1 is a cross sectional view of a display apparatus constructed in accordance with the present disclosure.

FIG. 2 is a cross sectional view of another embodiment of the display apparatus constructed in accordance with the present disclosure.

FIG. 3 is a perspective view of another embodiment of the display apparatus constructed in accordance with the present disclosure.

FIG. 4A is a side elevation view of a portion of the display apparatus constructed in accordance with the present disclosure.

FIG. 4B is a cross sectional view of a portion of the display apparatus constructed in accordance with the present disclosure.

### DETAILED DESCRIPTION OF THE DISCLOSURE

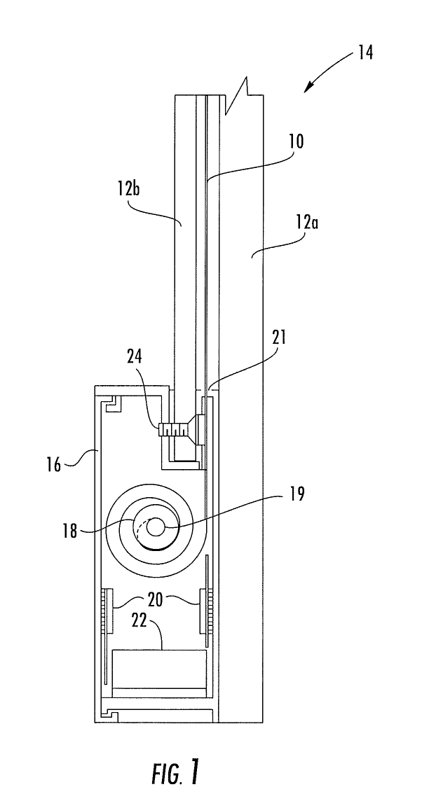

Referring now to the figures, and more particularly to FIG. 1, the present disclosure relates to a video display 10 that can be disposed on one side of a single piece/sheet of transparent material 12 or between two pieces/sheets of transparent material 12. The transparent material 12 can be comprised of any material such that video display 10 can be viewed through the transparent material 12. The video display 10 may also be flexible and movably disposed adjacent to or within the layers of transparent material 12. The flexibility of the video display 10 may be such that it can be rolled up and stored for a desirable amount of time. It should be understood and appreciated that the video display 10 can be viewed from either side of the video display 10.

Examples of transparent material 12 include, but are not limited to, glass, plexiglass, plastic, or any combination thereof. The transparent material 12 can be used in any known application for using transparent material 12. For example, the video display can be disposed adjacent to or between two layers of transparent material 12 in a window, door, wall, ceiling, barrier, walkway partition, moving sidewalk barrier, and the like.

The video display 10 can be any type of video display 10 known in the art that would be disposable adjacent to or between two pieces of transparent material 12. Examples of types of video displays include, but are not limited to OLED (organic light emitting diode) technology, AMOLED (active matrix light emitting diode) technology, LED, LCD or digital micro-mirror devices using digital light processing. The video display 10 can be moved adjacent to or within the pieces of transparent material 12 manually and/or mechanically.

The video display 10 can be included in a display apparatus 14. The display apparatus 14 includes a housing 16 to contain the video display 10 when it is rolled up, a motor 18 for rolling the video display 10 and unrolling the video display 10 around a roller 19 and through a port 21 disposed in the housing 16, a computer unit 20 to operate and control the display apparatus 14, and a power source 22 to provide electric power to the display apparatus. 14. It should be understood and appreciated that the computer unit 20 and the power source 22 do not have to be disposed or contained in the housing 16.

Either the computer unit 20 and/or the power source 22 could be stored externally from the housing 16 depending upon the configuration desired. For example, there could be multiple display apparatuses used concurrently wherein a single power source 22 and a single computer unit 20. In another embodiment, the housing 16 may also be sized and shaped such that the video display 10 does not have to be rolled up to be stored therein. It should be understood and appreciated that the computer unit 20 can include any hardware or software capable of running and operating the display apparatus 14 in any manner desirable. For example, the display apparatus 14 can be set up to operate as a television, computer, and the like. The power source 22 can be any type of a power source such as a dc or ac power source. The power can come from a battery, a power cord plugged into an outlet or it could come from being hardwired into the structure the display apparatus 14 is included in.

The housing 16 can be secured to at least one piece of transparent material 12 via any manner known in the art, such as screws, adhesives, and the like. In one embodiment shown in FIG. 1, the housing 16 is secured to the one piece of transparent material 12 via a screw 24. The housing 16 can also be configured to be mountable to some other surface such as the floor, ceiling, walls, internal portions of window frames, door frames, and the like. The pieces of transparent material 12 can be removably attached to the housing 16. Furthermore, the pieces of transparent material 12 do not have to cover the entire video display 10. In one embodiment, the pieces of transparent material 12 can be attached to the housing 16 such that it creates a channel that guides the video display 10 as it extends from the housing 16.

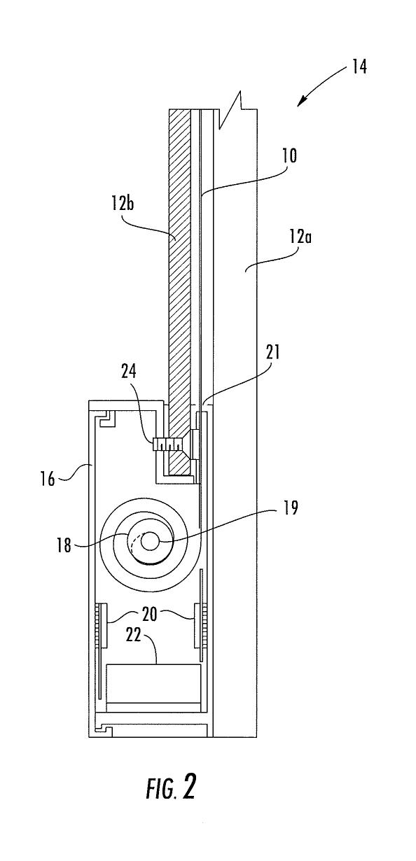

The embodiment shown in FIG. 1 shown the video display 10 disposed between a first piece of transparent material 12a and a second piece of transparent material 12b. FIG. 2 shows the video display 10 disposed between a piece of transparent material 12 on the front side of the video display 10 and a protective sheet of material 25 on the back side of the video display 10.

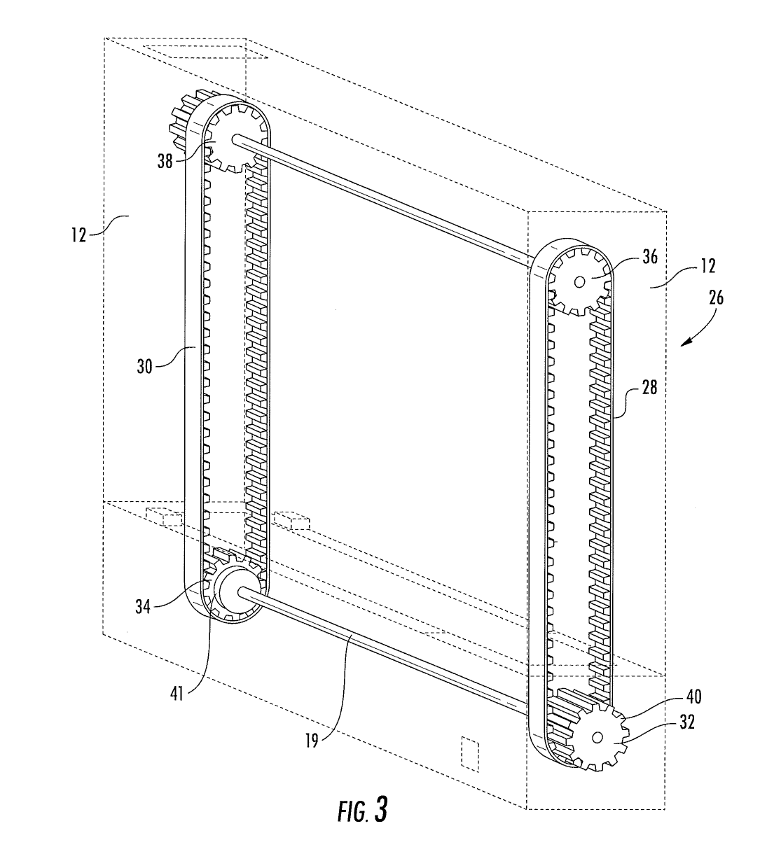

The display apparatus 14 can further include an extraction/retraction apparatus 26 (one example shown in FIG. 3) for guiding and controlling the video display 10 as the video display 10 is extended out of the housing 16. The extraction/retraction apparatus 26 can be any type of device that can function with the video display 10 to control and guide the video display 10 from the housing 16 adjacent to a single piece of transparent material 12 or between two pieces of transparent material 12. The display apparatus 14 can be set up where portions of it can be operated manually or with a remote control device. The display apparatus 14 can also be designed such that it could operate with a keyboard or any other type of device used with computers. In one embodiment, the keyboard could be a wireless keyboard.

In one embodiment shown in FIG. 3, the extraction/retraction apparatus 26 can include a first belt 28 engagable with one side of the video display 10 and a second belt 30 engagable with the other side of the video display 10. The first belt 28 is designed such that it can extend around a first gear 32 that is engaged with the motor 18. The second belt 30 is designed such that it can extend around a turning element 34 rotatably disposed on the other side of the roller 19 from the first gear 32. The extraction/retraction apparatus 26 can also include a second gear 36 rotatably supported by the transparent material 12 via a bracket or something similar extending from the piece of transparent material 12. The first belt 28 engages with the second gear 26 to extract the video display 10 from the housing 16 via the port 21. The extraction/retraction apparatus 26 can also include a second turning element 38 rotatably supported by the transparent material via a bracket or something similar extending from the piece of transparent material 12.

In another embodiment, the first and second turning elements 34 and 38 can be a gear to engage with the second belt 30. In another embodiment, the first and second belts 28, 30 can include a plurality of teeth 40 to engage with the first and second gears 32, 36 and the first and second turning elements 34 and 38. Thus, when the motor 18 is turned on it engages and rotates the first gear 32 which rotates the first belt 28 around the first gear 32 and the first turning element 34. Additionally, a second motor 41 can also be used to rotate the first turning element 34.

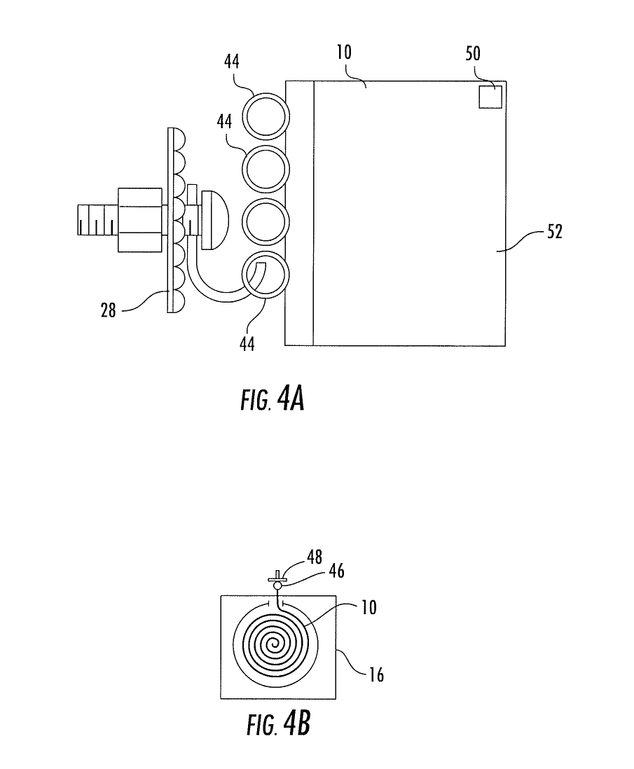

In one embodiment, the first and second belts 28 and 30 can be actually attached to the video display 10. In another embodiment shown in FIG. 4A, the first and second belts 28 and 30 can have a plurality of hooks 42 disposed thereon which operate to engage a plurality of loops 44 disposed on the sides of the video display 10. As the belts 28, 30 are rotated, the hooks 42 disposed on the belts 28, 30 will engage with the loops 44 disposed on the sides of the video display 10. Once the hooks 42 are engaged with the loops 44, the video display 10 is extracted from the housing 16 through the port 21.

The video display 10 can include a rod element 46 disposed across the top. The rod element 46 can have a magnetic portion such that when the video display 10 is fully extended from the housing 16, the rod element 46 engages a portion of whatever structure the display apparatus 14 is disposed in. In another embodiment, the magnetic portion of the rod element 46 can engage another rod element of another video display 10 of another display apparatus 14. A structure, such as a window, that employs the display apparatus 14 can include multiple display apparatuses 14 to cover the desirable area of the structure. The rod element 46 may be sized such that the length of it is longer than the port 21 so that the video display 10 does not get completely withdrawn into the housing 16. In another embodiment shown in FIG. 4B, a guard element 48 is disposed adjacent to the rod element 46 and it is wider than the port 21 such that the video display is prevented from being extracted completely into the housing 16.

In yet another embodiment shown in FIG. 4A, the display apparatus can include a camera 50 and accompanying software and hardware to make the camera 50 operational. The camera 50 can be positioned on a backside portion of the display apparatus 14 such that an outside view could be captured and displayed on another display apparatus 14 located in another area.

In one embodiment, there can be multiple display apparatuses 14 disposed between separate pieces of transparent material 12 wherein the separate pieces of transparent material 12 can be interconnected such that each separate display apparatus 14 can cooperate and communicate with the other display apparatuses 14 to generate one large video display. It should be understood that each separate display apparatus 14 can display its own separate image/video as opposed to being included in one large video display. In another embodiment, the display apparatus 14 can include a router to be able to communicate with routers included in other display apparatuses 14.

In another embodiment of the present disclosure, thermal or heat resistant materials/panels/sheets of material can be used to refract and/or divert heat away from the video displays 10. In one example, the thermal and/or heat resistant material/panels/sheets of material can be attached to the back of the video display 10. The display apparatus 14 or pieces of transparent material 12 can be equipped with a temperature sensor so the video display 10 can be removed from between the separate pieces of transparent material 12 and into the housing 16 to protect the video display 10 from extreme hot and/or cold temperatures.

The display apparatuses 14 can be provided with a plurality of output terminals. The output terminals can include, but are not limited to speakers, video outputs (such as hdmi, dvi, components), audio outputs (such as hdmi, optical audio, etc.), usb ports, and the like.

In a further embodiment, the video display 10 can incorporate the properties of a volumetric display device that forms a representation of an object in three physical dimensions (or 3-D imagery). The volumetric display can use, but is not limited to autostereoscopic or automultiscopic technology. Other types of 3-D displays that can be used include steriograms/sterioscopes, view sequential displays, electroholographic displays, parallax panoramagrams re-imaging systems and others.

In yet another embodiment of the present disclosure, the display apparatus 14 can include a flexible solar panel 52 along with the video display 10 or in lieu of the video display 10. In one embodiment, a window can have a display apparatus 14 that extends a video display 10 in between the pieces of transparent material 12 and a second display apparatus 14 that extends the flexible solar panel 52 into the same space between the pieces of transparent material 12 as the video display 10. The flexible solar panel 52 would be disposed on the non-viewing side of the video display 10 between the pieces of transparent material 12. In a further embodiment, the display apparatus 14 can include a shading film disposed in retractably disposed therein to provide a shading effect.

From the above description, it is clear that the present invention is well adapted to carry out the objectives and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A display apparatus, the display apparatus comprising:
a first sheet of transparent material supported by a housing; and
a video display having an extended position out of the housing and a retracted position in the housing, the video display disposed adjacent to the first sheet of transparent material when the video display is in the extended position.

2. The apparatus of claim 1 wherein the video display is flexible and rolled up in the housing when the video display is in the retracted position.

3. The apparatus of claim 1 further comprising a second sheet of transparent material supported by the housing wherein the video display is disposed between the first and second sheet of transparent material when the video display is in the extended position.

4. The apparatus of claim 1 further comprising a mechanical apparatus to extend the video display from the housing and retract the video display into the housing.

5. The apparatus of claim 3 wherein the first and second sheets of transparent material are included in a window or a door.

6. The apparatus of claim 4 wherein the mechanical apparatus and the display apparatus can be operated by a remote control device.

7. The apparatus of claim 1 wherein a keyboard can be used in conjunction with the display apparatus.

8. The apparatus of claim 3 wherein the first and second sheets of material do not cover the entire video display.

9. The apparatus of claim 5 further includes a second housing that includes a flexible solar panel having an extended position out of the housing and a retracted position in the housing, the flexible solar panel disposed on an outside part of the video display.

10. The apparatus of claim 1 further comprising a camera directed toward an outside direction in any structure the display apparatus is incorporated in.

11. The apparatus of claim 1 further comprising a temperature sensor that provides a signal to cause the display apparatus to automatically retract the video display into the retracted position in the housing when the video display reaches a predetermined temperature.

12. A display apparatus, the display apparatus comprising:
a first sheet of transparent material supported by a housing; and
a flexible solar panel having an extended position out of the housing and a retracted position in the housing, the flexible solar panel disposed adjacent to the first sheet of transparent material when the flexible solar panel is in the extended position.

13. The apparatus of claim 12 wherein the flexible solar panel is flexible and rolled up in the housing when the flexible solar panel is in the retracted position.

14. The apparatus of claim 12 further comprising a second sheet of transparent material supported by the housing wherein the flexible solar panel is disposed between the first and second sheet of transparent material when the flexible solar panel is in the extended position.

15. The apparatus of claim 12 further comprising a mechanical apparatus to extend the flexible solar panel from the housing and retract the flexible solar panel into the housing.

16. The apparatus of claim 14 wherein the first and second sheets of transparent material are included in a window or a door.

17. The apparatus of claim 15 wherein the mechanical apparatus and the display apparatus can be operated by a remote control device.

18. The apparatus of claim 14 wherein the first and second sheets of material do not cover the entire flexible solar panel.
